(19) United States
(12) Patent Application Publication
(10) Pub. No.: US 2014/0253450 A1
(43) Pub. Date: Sep. 11, 2014

(54) METHODS AND APPARATUS FOR CONTROLLING A COMPUTER USING A WIRELESS USER INTERFACE DEVICE

(71) Applicant: DME Development Corporation,International, Chicago, IL (US)

(72) Inventors: James A. Erwin, Chicago, IL (US); Antonio R. Rivera, Romeoville, IL (US)

(73) Assignee: DME Development Corporation,International, Chicago, IL (US)

(21) Appl. No.: 14/200,290

(22) Filed: Mar. 7, 2014

Related U.S. Application Data
(60) Provisional application No. 61/774,171, filed on Mar. 7, 2013.

(51) Int. Cl. G06F 3/0354; G06F 3/041; G06F 3/0346

(52) U.S. Cl. CPC G06F 3/03543; G06F 3/0346; G06F 3/041
USPC 345/163

(57) ABSTRACT

Methods and apparatus for controlling a computer using a wireless user interface device are disclosed. A wireless user interface device displays one or more mouse button areas and one or more application launch areas. In addition, the wireless user interface device detects motion of the wireless user interface device. When a user selects a mouse button area and/or an application launch area, the wireless user interface device transmits corresponding information to the host computing device. In addition, the wireless user interface device transmits motion associated with the wireless user interface device to the host computing device. The host device receives the data from the wireless user interface device and takes appropriate action(s). For example, the host device may move a cursor, execute a mouse click, and/or launch an application.

### RELATED APPLICATIONS

This application claims priority to Provisional Application Ser. No. 61/774,171, filed on Mar. 7, 2013, having inventors James A. Erwin et al., titled “METHODS AND APPARATUS FOR CONTROLLING A COMPUTER USING A WIRELESS USER INTERFACE DEVICE”, and is incorporated herein by reference.

### TECHNICAL FIELD

The present disclosure relates in general to computer input devices, and, in particular, to methods and apparatus for controlling a computer using a wireless user interface device.

### BACKGROUND

Typically, laptop computers include a track pad, isopoint, and/or touch screen for controlling cursor movement and user interface selections. However, many users are more comfortable using a traditional mouse attached to the computer. As a result, these users often travel with both their laptop computer and a separate mouse. However, travelling with a mouse creates an additional burden in that the user must remember to pack the mouse, and the mouse uses a certain amount of luggage space and weight.

### BRIEF DESCRIPTION OF THE DRAWINGS

FIG. 1 is a block diagram of an example network communication system.

FIG. 2 is a block diagram of an example electronic device.

FIG. 3 is block diagram of an example wireless user input device and an associated host device.

FIG. 4 is an example screen shot showing left and right mouse click areas and four quick launch application areas on a touch screen.

FIG. 5 is a flowchart of an example process for controlling a computer using a wireless user interface device.

### DETAILED DESCRIPTION OF THE PREFERRED EMBODIMENTS

Briefly, methods and apparatus for controlling a computer using a wireless user interface device are disclosed. In general, a wireless user interface device displays one or more mouse button areas and one or more application launch areas. In addition, the wireless user interface device detects motion of the wireless user interface device. When a user selects a mouse button area and/or an application launch area, the wireless user interface device transmits corresponding information to the host computing device. In addition, the wireless user interface device transmits motion associated with the wireless user interface device to the host computing device. The host device receives the data from the wireless user interface device and takes appropriate action(s). For example, the host device may move a cursor, execute a mouse click, and/or launch an application.

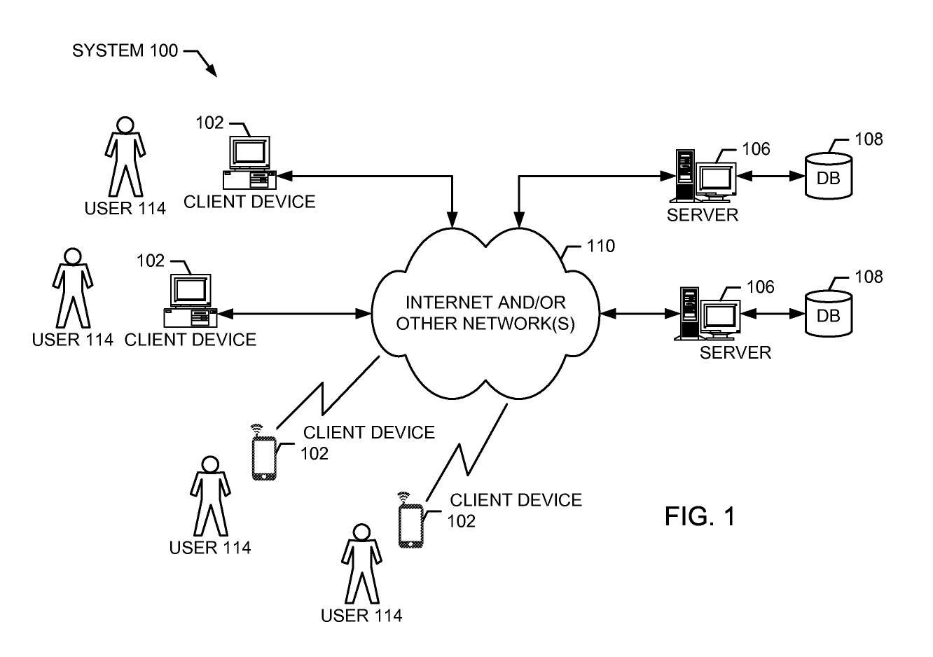

In order to put the disclosed system in context, a block diagram of certain elements of an example network communications system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

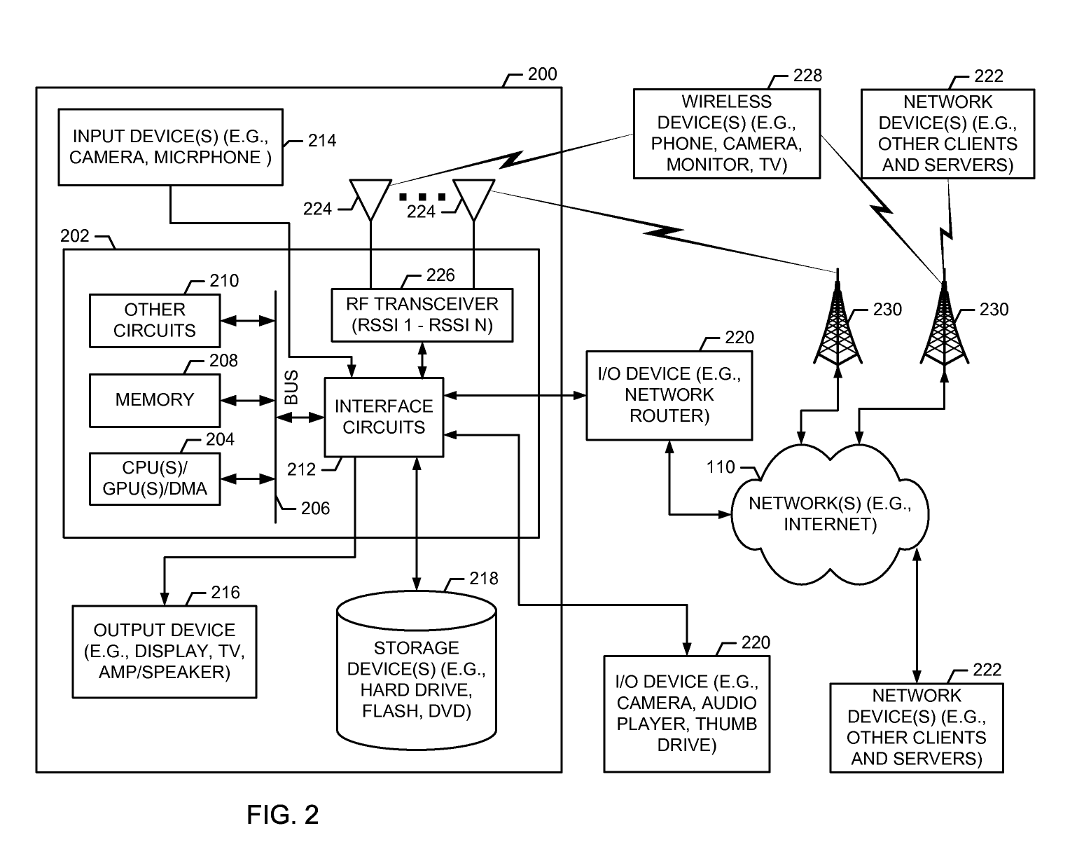

Each of the devices illustrated in FIG. 1 (e.g., client 102 and/or server 106) may include certain common aspects of many electronic devices such as microprocessors, memories, direct memory access units, peripherals, etc. FIG. 2 is a block diagram of an example electronic device. For example, the electrical device 200 may be a client, a server, a camera, a phone, and/or a television.

The example electrical device 200 includes a main unit 202 which may include, if desired, one or more processing units 204 electrically coupled by an address/data bus 206 to one or more memories 208, other computer circuitry 210, and one or more interface circuits 212. The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, isopoint, camera, voice recognition system, accelerometer, global positioning system (GPS), and/or any other suitable input device.

One or more displays, printers, speakers, monitors, televisions, high definition televisions, and/or other suitable output devices 216 may also be connected to the main unit 202 via the interface circuit 212. Output devices 216 typically consume uncompressed data, such as uncompressed audio and/or video data. For example, a display for displaying decompressed video data may be a cathode ray tube (CRTs), liquid crystal displays (LCDs), electronic ink (e-ink), and/or any other suitable type of display.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200.

The electrical device 200 may also exchange data with one or more input/output (I/O) devices 220. I/O devices 220 typical produce and/or consume data, such as audio and/or video data. For example, I/O devices 220 may include network routers, camera, audio players, thumb drives etc.

The electrical device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 of the system 100 may be required to register with a server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

In some embodiments, the device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a blue tooth transceiver 216, a Wi-Fi transceiver 216, and diversity cellular transceivers 216. The transceiver 226 allows the device 200 to exchange signals, such as voice, video and any other suitable data, with other wireless devices 228, such as a phone, camera, monitor, television, and/or high definition television. For example, the device 200 may send and receive wireless telephone signals, text messages, audio signals and/or video signals directly and/or via a base station 230. A receive signal strength indicator (RSSI) associated with each receiver generates an indication of the relative strength or weakness of each signal being received by the device 200.

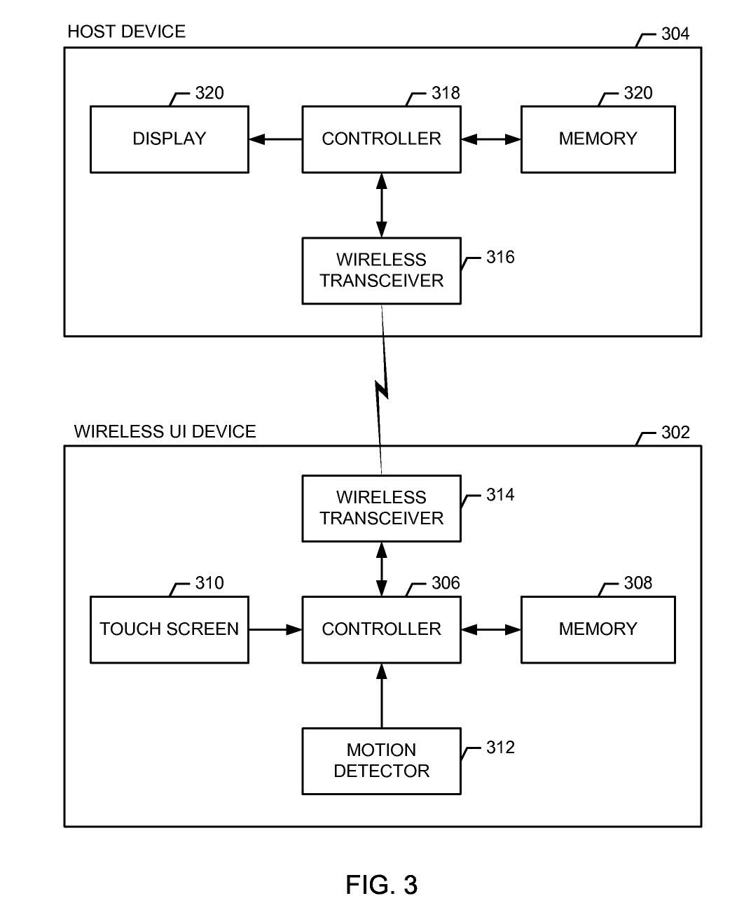

FIG. 3 is a block diagram including an example wireless user interface device 302 and an example host device 304. The wireless user interface device 302 may by any suitable electronic device. For example, the wireless user interface device 302 may be a smart phone. The host device 304 may also by any suitable electronic device. For example, the host device 304 may be a desktop computer, laptop computer, or tablet computer.

In this example the wireless user interface device 302 includes a controller 306 operatively coupled to a memory device 308, a touch screen device 310, a motion detector 312, and a wireless transceiver 314. The memory device 308 stores a software program which causes the controller 306 to operate the wireless user interface device 302.

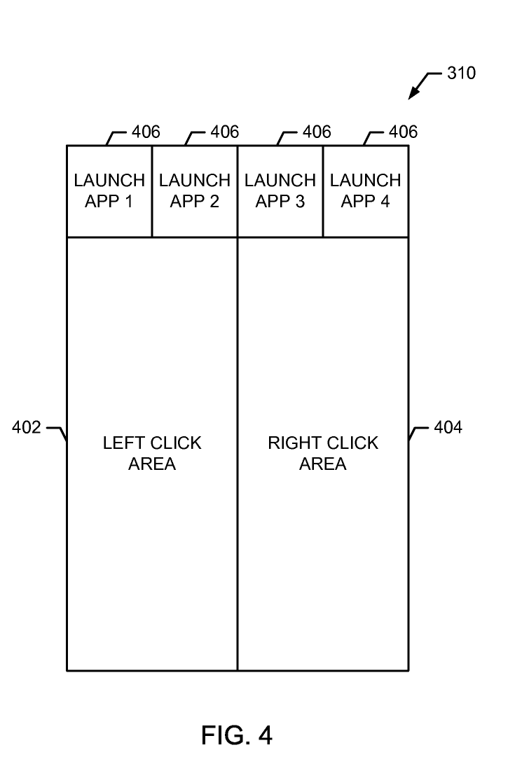

During operation, the controller 306 receives data from the touch screen 310 and the motion detector 312. The data from the touch screen 310 is indicative of user selections on the touch screen 310. For example, a user 114 may click in a left mouse click area 402, a right mouse click area 404, and/or one or more application launch areas 406 as described below with reference to FIG. 4. The data from the motion detector 312 is indicative of motion of the wireless user interface device 302. For example, the motion detector 312 may be an accelerometer, a gyroscope, and/or a camera producing data indicative of motion in one, two, and/or three dimensional space.

Data from the touch screen 310 and the motion detector 312 are sent from the controller 306 to the wireless transceiver 314 for transmission to the host device 304 via the host device wireless transceiver 316. For example, the wireless transceivers 314 and 316 may be Bluetooth transceivers and/or WiFi transceivers.

The host device 304 also has a controller 318 operatively coupled to another memory device 320. The memory device 320 stores another software program which causes the controller 318 to operate the host device 304.

During operation, the host controller 318 receives data from the touch screen 310 and the motion detector 312 via the host device wireless transceiver 316. When the host device 304 receives touch screen and/or motion detector data from the wireless user interface device 302, the controller 318 interprets the data and causes changes to an output of the display 320. For example, when the wireless user interface device 302 is moved (e.g., across a surface), the motion detector 312 indicates this motion to the controller 306. Data indicative of this motion is then transmitted to the host device 304 via the wireless transceiver 314 and the wireless transceiver 316. The controller 318 in the host device 304 may then cause a cursor on the display 320 to move in accordance with the motion detected by the motion detector 312.

Similarly, when the touch screen 310 senses mouse clicks and/or application launch clicks, the touch screen 310 sends data indicative of the mouse clicks to the controller 306. The controller 306 transmits this data, or related data, to the host device 304 via the UI wireless transceiver 314 and the host wireless transceiver 316. The host device 304 then causes the display 320 to operate according to the touch screen commands. For example, if the user 114 presses the left or right mouse button, the corresponding action is taken on the display 320. If the user 114 launched an application via one of the application launch areas 406, the host device 304 launches the indicated application and shows the application on the display 320.

FIG. 4 is a screen shot of an example touch screen 310. In this example, the touch screen 310 includes a left mouse click area 402, a right mouse click area 404, and four quick launch application areas 406. When a user 114 touches the left click mouse area 402, the wireless user interface device 302 transmits this information to the host device 304, which takes appropriate left mouse click action. For example, if the user 114 left clicks on an icon, typically the host device 304 would select that icon. Similarly, when the user 114 touches the right mouse click area 404, the wireless user interface device 302 transmits data to the host device 304, which again takes appropriate right mouse click action. For example, if the user 114 right clicks on an icon the host device 304 would typically show a drop-down menu of actions that were available for that icon.

If the user 114 touches one of the application launch areas 406 areas, corresponding information is also sent to the host device 304. In this case, the host device 304 preferably launches the appropriate application. For example, the user 114 may click the first application launch area 406 in order to launch Microsoft Word and the second application launch area 406 to launch Microsoft Excel. Preferably each of these application launch areas 406 is configurable by the user. For example, the user 114 may setup any suitable application launch area 406 to launch any suitable application on the host device 304 using setup software on the wireless user interface device 302 and/or the host device 304.

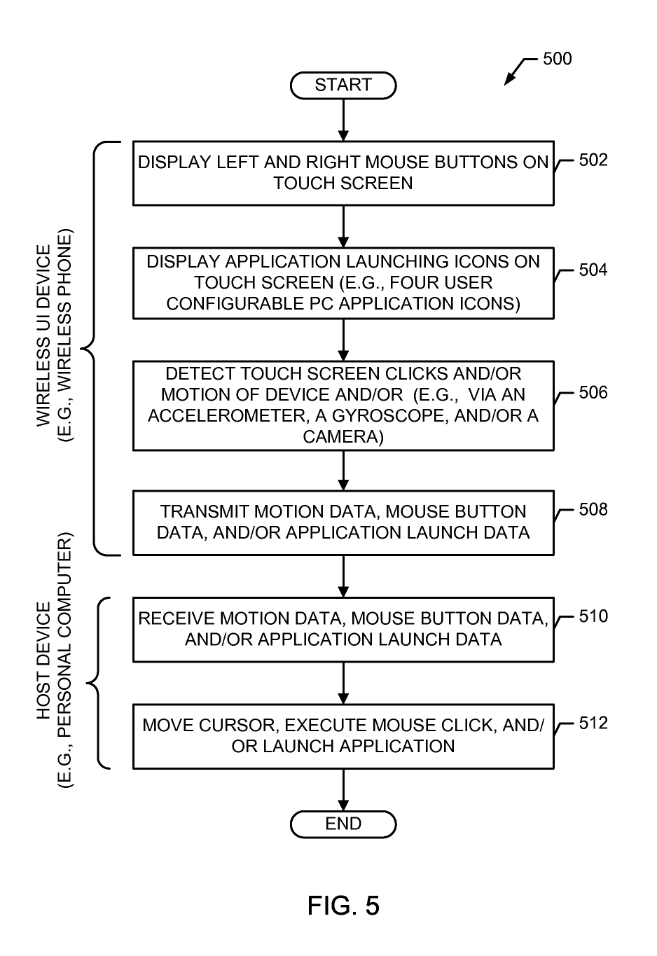

FIG. 5 is a flowchart of an example process 500 for controlling a computer using a wireless user interface device. The process 500 may be carried out by one or more suitably programmed processors such as a CPU executing software (e.g., block 204 of FIG. 2). The process 500 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 500 is described with reference to the flowchart illustrated in FIG. 5, it will be appreciated that many other methods of performing the acts associated with process 500 may be used. For example, the order of many of the operations may be changed, and some of the operations described may be optional.

In general, the process 500 includes a first portion executed by a wireless user interface device 302 and a second portion executed by a host device 304. The wireless user interface device 302 displays one or more mouse button areas 402, 404 and one or more application launch areas 406. In addition, the wireless user interface device 302 detects motion of the wireless user interface device 302. When the user 114 selects one of the mouse button areas 402, 404 or application launch areas 406, the wireless user interface device 302 transmits corresponding information to the host device 304. In addition, the wireless user interface device 302 transmits motion associated with the wireless user interface device 302 to the host device 304. The host device 304 receives the data from the wireless user interface device 302 and takes appropriate action(s). For example, the host device 304 may move a cursor, execute a mouse click, and/or launch an application.

More specifically the process 500 begins when the wireless user interface device 302 displays a left mouse button area 402 and/or a right mouse buttons area 404 on a touch screen 310 (block 502). In addition, the wireless user interface device 302 preferably displays one or more application launch areas 406 on the touch screen 310 (block 504). For example, the wireless user interface device 302 may display four user-configurable personal computer application icons.

The wireless user interface device 302 than detects touch screen changes and/or motion of the device 302 in one or more directions (block 506). For example the wireless user-interface device may detect motion across a flat surface using an accelerometer, a gyroscope, and/or a camera. Once touch screen changes and/or motion is detected, the wireless user interface device 302 transmits associated motion data, mouse button data, and/or application launch data to the host device (block 508). For example, the wireless user interface device 302 may transmit left mouse clicks, right mouse clicks, XY coordinate motion, XYZ coordinate motion, and/or application launch data to the host device 304.

The host device 304 then receives then receives the motion data, mouse button data, and/or application launch data (block 510) and takes one or more appropriate actions (block 512). For example the host device 304 may use the received data to move a cursor, execute mouse clicks, and/or launch applications at the host device 304.

In summary, persons of ordinary skill in the art will readily appreciate that methods and apparatus for controlling a computer using a wireless user interface device have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. An apparatus for controlling a computer, the apparatus comprising:
a controller;
a motion detector operatively coupled to the controller;
a wireless transceiver operatively coupled to the controller;
a touch sensitive display operatively coupled to the controller, wherein the touch sensitive display displays a plurality of buttons including a left mouse button, a right mouse button adjacent to the left mouse button, and at least one application launching icon above the left mouse button and the right mouse button; and
a memory device operatively coupled to the controller, wherein the memory device stores software structured to cause the controller to transmit mouse data indicative of (a) motion detected by the motion detector, and (b) touch selections of the plurality of buttons to a host application on a computing device via the wireless transceiver, wherein the host application causes a cursor on the computing device to operate according to the mouse data.

2. The apparatus of claim 1, wherein the host application causes the computing device to launch an application on the computing associated with the at least one application launching icon.

3. The apparatus of claim 2, wherein the application associated with the at least one application launching icon is user configurable.

4. The apparatus of claim 1, wherein the motion detector includes an accelerometer.

5. The apparatus of claim 1, wherein the motion detector includes a gyroscope.

6. The apparatus of claim 1, wherein the motion detector includes a camera.

7. A method of controlling a computer, the method comprising:
displaying a plurality of buttons including a left mouse button, a right mouse button adjacent to the left mouse button, and at least one application launching icon above the left mouse button and the right mouse button on a touch sensitive display;
detecting a motion associated with the touch sensitive display; and
transmitting mouse data indicative of (a) the motion associated with the touch sensitive display, and (b) touch selections of the plurality of buttons to a host application on a computing device via a wireless transceiver.

8. The method of claim 7, further comprising:
receiving the mouse data at the computing device; and
causing a cursor on the computing device to operate according to the mouse data.

9. The method of claim 7, further comprising:
receiving the mouse data at the computing device; and
launching an application on the computing associated with the at least one application launching icon.

10. The method of claim 9, wherein the application associated with the at least one application launching icon is user configurable.

11. The method of claim 7, wherein detecting the motion associated with the touch sensitive display includes receiving data from an accelerometer.

12. The method of claim 7, wherein detecting the motion associated with the touch sensitive display includes receiving data from a gyroscope.

13. The method of claim 7, wherein detecting the motion associated with the touch sensitive display includes receiving data from a camera.

14. A computer readable memory storing a software application, the software application enabling an apparatus to:
display a plurality of buttons including a left mouse button, a right mouse button adjacent to the left mouse button, and at least one application launching icon above the left mouse button and the right mouse button on a touch sensitive display;
detect a motion associated with the touch sensitive display; and
transmit mouse data indicative of (a) the motion associated with the touch sensitive display, and (b) touch selections of the plurality of buttons to a host application on a computing device via a wireless transceiver.

15. The computer readable memory of claim 14, wherein the software application enables the apparatus to:
receive the mouse data at the computing device; and
cause a cursor on the computing device to operate according to the mouse data.

16. The computer readable memory of claim 14, wherein the software application enables the apparatus to:
receive the mouse data at the computing device; and
launch an application on the computing associated with the at least one application launching icon.

17. The computer readable memory of claim 14, wherein the application associated with the at least one application launching icon is user configurable.

18. The computer readable memory of claim 14, wherein the software application is structured to enable the apparatus to detect a motion associated with the touch sensitive display by receiving data from an accelerometer.

19. The computer readable memory of claim 14, wherein the software application is structured to enable the apparatus to detect a motion associated with the touch sensitive display by receiving data from a gyroscope.

20. The computer readable memory of claim 14, wherein the software application is structured to enable the apparatus to detect a motion associated with the touch sensitive display by receiving data from a camera.
